(19) United States
(12) Patent Application Publication
(10) Pub. No.: US 2008/0033895 A1
(43) Pub. Date: Feb. 7, 2008

(54) Apparatus and method for detecting sequential pattern

(75) Inventor: Shigeaki Sakurai, Tokyo (JP)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 11/725,696

(22) Filed: Mar. 20, 2007

(30) Foreign Application Priority Data
Aug. 1, 2006 (JP) 2006-210202

(51) Int. Cl. G06F 15/18

(52) U.S. Cl. 706/13

(57) ABSTRACT

A sequential pattern detecting apparatus includes a first combining unit configured to combine a plurality of characteristic event sets detected from sequential data containing elements which comprise a plurality of events and which are arranged in sequential order, to generate a characteristic primary sequential pattern with a sequence size of “1”, a second combining unit configured to combine a plurality of characteristic ith-length (i=1, 2, . . . ) sequential patterns with a sequence size of “i” to generate a candidate (i+1)th-length sequential pattern, a checking unit configured to check validity of the candidate (i+1)th-length sequential pattern on the basis of the attributes to detect valid (i+1)th-length sequential patterns, and a detecting unit configured to detect a characteristic (i+1)th-length sequential pattern from the valid (i+1)th-length sequential patterns with reference to the sequential data.

### CROSS-REFERENCE TO RELATED APPLICATIONS

This application is based upon and claims the benefit of priority from prior Japanese Patent Application No. 2006-210202, filed Aug. 1, 2006, the entire contents of which are incorporated herein by reference.

### BACKGROUND OF THE INVENTION

1. Field of the Invention

The present invention relates to a sequential pattern detecting apparatus and a method for detecting a characteristic sequential pattern in sequential data.

2. Description of the Related Art

A method for detecting characteristic sequential patterns in sequential data composed of discrete events is disclosed in, for example, “Mining Sequential Patterns” (R. Agrawal and R. Srikant Pro. of the 11th Int. Conf. Data Engineering, 3-14, 1995) (hereinafter referred to as Document 1). This method detects, for example, events exhibiting an frequency equal to or larger than a reference value in a certain year, as characteristic events. These characteristic events are combined with one another to produce candidate sequential patterns. From these candidate sequential patterns a candidate sequential pattern having an frequency not less than a reference value is detected as a characteristic sequential pattern. A similar process is performed every year to detect characteristic sequential patterns.

The reference value may be, for example, a support of a sequential pattern defined in Formula (1).

Support=(number of sequential data containing the sequential pattern)/(number of sequential data) (1)

The support has the property of decreasing monotonously with the sequence size of a partial sequential pattern contained in a sequential pattern. Accordingly, all characteristic sequential patterns can be efficiently detected by shifting from detection of smaller sequential patterns to detection of larger sequential patterns step by step. That is, first, characteristic sequential patterns with a smaller sequential size are detected. Then, the detected sequential patterns are combined into larger candidate sequential patterns. Then, determination is made as to whether or not each of the candidate sequential patterns is characteristic. The series of processes are repeated.

However, the conventional method for detecting a sequential pattern generates candidate sequential patterns for all combinations of original sequential patterns. As a result, the number of candidate sequential patterns increases explosively with the number of events constructing each sequential pattern. Thus, the detection of characteristic sequential patterns unfortunately requires many calculations and much time.

To solve this problem, the number of candidate sequential patterns may be reduced by, for example, limiting the number of events or setting a high reference value for the determination as to whether or not the candidate sequential pattern is characteristic. However, setting a high reference value limits the number of candidate sequential patterns generated, resulting in the high possibility of overlooking otherwise characteristic sequential patterns. This may reduce the accuracy with which characteristic sequential patterns are detected.

### BRIEF SUMMARY OF THE INVENTION

According to an aspect of the invention, there is provided that A sequential pattern detecting apparatus comprising: a first combining unit configured to combine a plurality of characteristic event sets detected from sequential data containing elements which comprise a plurality of events and which are arranged in sequential order, to generate a candidate event set; a first checking unit configured to check validity of the candidate event set on the basis of attributes of the events to detect a valid event set; a first detecting unit configured to detect a characteristic primary sequential pattern with a sequence size of “1” from the valid event set with reference to the sequential data; a second combining unit configured to combine a plurality of characteristic ith-length (i=1, 2, . . . ) sequential patterns with a sequence size of “i” to generate a candidate (i+1)th-length sequential pattern; a second checking unit configured to check validity of the candidate (i+1)th-length sequential pattern on the basis of the attributes to detect valid (i+1)th-length sequential patterns; and a second detecting unit configured to detect a characteristic (i+1)th-length sequential pattern from the valid (i+1)th-length sequential patterns with reference to the sequential data.

### BRIEF DESCRIPTION OF THE SEVERAL VIEWS OF THE DRAWING

FIG. 1 is a block diagram showing a sequential pattern detecting apparatus according an embodiment.

FIG. 2 is a block diagram showing a common unit of the sequential pattern detecting apparatus in FIG. 1.

FIG. 3 is a flowchart showing an entire process performed by the sequential pattern detecting apparatus in FIG. 1.

FIG. 4 is a flowchart showing an event detecting process included in the process in FIG. 3.

FIG. 5 is a flowchart showing an event set detecting process included in the process in FIG. 3.

FIG. 6 is a flowchart showing a sequential pattern detecting process included in the process in FIG. 3.

FIG. 7 is a diagram showing an example of sequential data stored in a sequential data storage unit in FIG. 1.

FIG. 8 is a diagram showing an example of attribute information stored in an attribute information storage unit in FIG. 1.

FIG. 9 is a diagram showing candidate event sets each comprising one event and their frequencies.

FIG. 10 is a diagram showing characteristic event sets each comprising one event.

FIG. 11 is a diagram showing candidate event sets each comprising two events and their frequencies.

FIG. 12 is a diagram showing characteristic event sets each comprising two events.

FIG. 13 is a diagram showing candidate event sets each comprising three events and their frequencies.

FIG. 14 is a diagram showing characteristic primary sequential patterns.

FIG. 15 is a diagram showing candidate secondary sequential patterns and their frequencies.

FIG. 16 is a diagram showing characteristic secondary sequential patterns.

FIG. 17 is a diagram showing candidate tertiary sequential patterns and their frequencies.

FIG. 18 is a diagram showing characteristic tertiary sequential patterns.

FIG. 19 is a diagram showing candidate quartic sequential patterns and their frequencies.

FIG. 20 is a diagram showing an example of hierarchical attribute information.

FIG. 21 is a diagram further illustrating the hierarchical attribute information shown in FIG. 20.

### DETAILED DESCRIPTION OF THE INVENTION

An embodiment of the present invention will be described below with reference to the drawings.

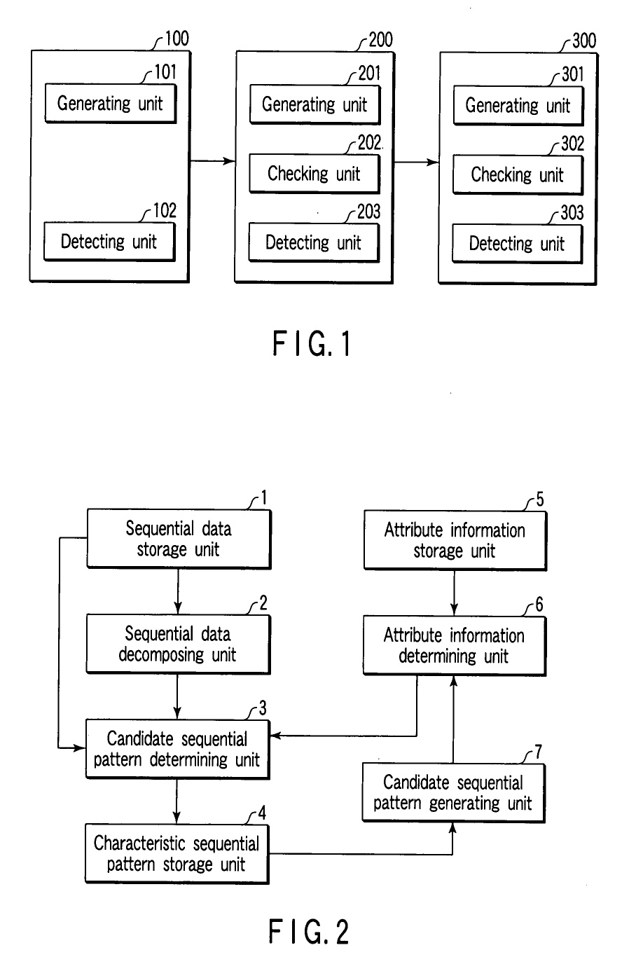

As shown in FIG. 1, a sequential pattern detecting apparatus in accordance with the present invention includes an event detecting unit 100, an event set detecting unit 200 connected to the event detecting unit 100, and a sequential pattern detecting unit 300 connected to the event set detecting unit 200. The event detecting unit 100 includes a generating unit 101 and a detecting unit 102. The event set detecting unit 200 includes a generating unit 201, a checking unit 202, and a detecting unit 203. The sequential pattern detecting unit 300 includes a generating unit 301, a checking unit 302, and a detecting unit 303. The event detecting unit 100, event set detecting unit 200, and sequential pattern detecting unit 300 have a common unit. As shown in FIG. 2, the common unit includes a sequential data storage unit 1, a sequential data decomposing unit 2 connected to the sequential data storage unit 1, a candidate sequential pattern detecting unit 3 connected to the sequential data storage unit 1 and the sequential data decomposing unit 2, a characteristic sequential pattern storage unit 4 connected to the candidate sequential pattern detecting unit 3, an attribute information storage unit 5, an attribute information determining unit 6 connected to the candidate sequential pattern detecting unit 3 and the attribute information storage unit 5, and a candidate sequential pattern generating unit 7 connected to the characteristic sequential pattern storage unit 4 and the attribute information determining unit 6.

The present embodiment can accurately and quickly detect a sequential pattern following a variation in the event belonging to the same attribute, in sequential data in which elements composed of plural events are sequentially arranged.

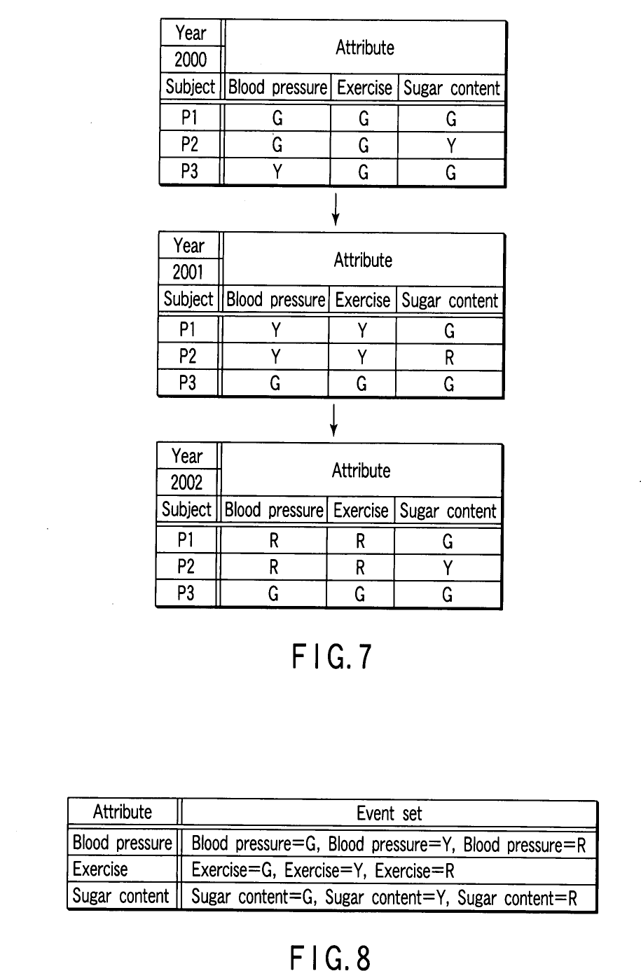

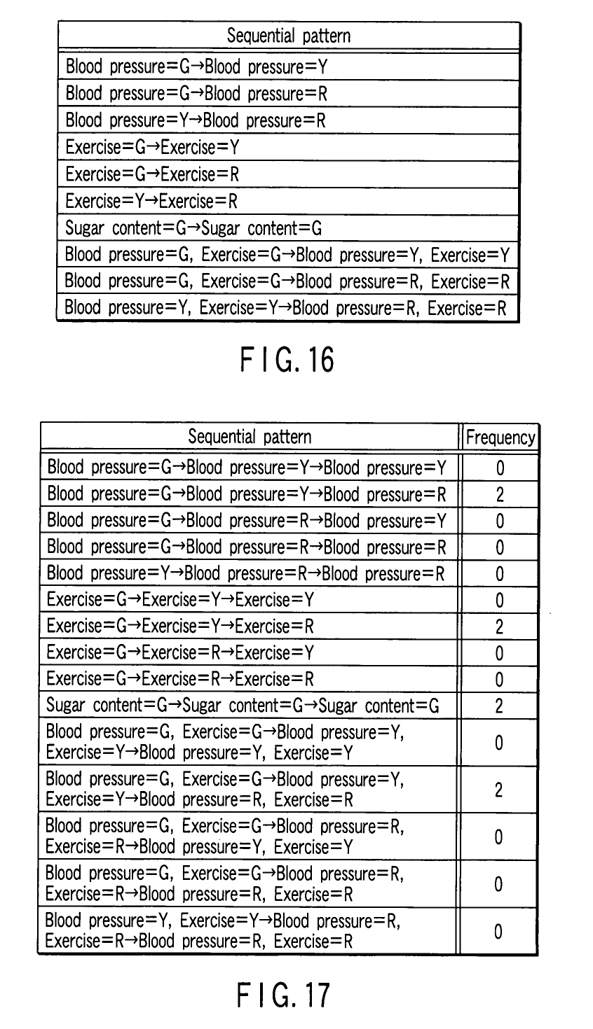

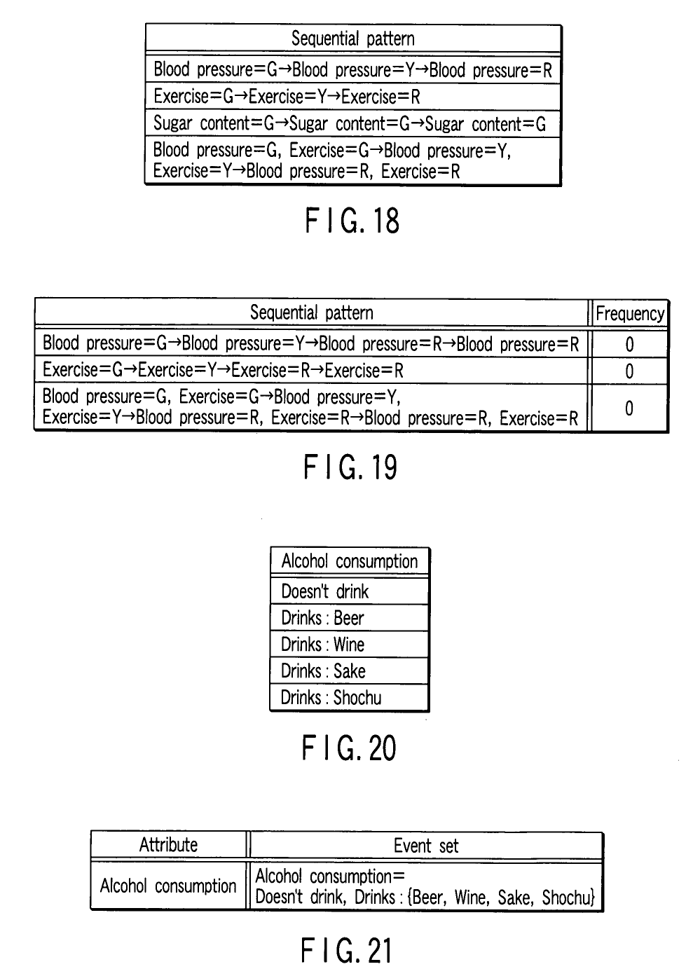

Before description, several terms used in the specification are described below. The elements composed of plural events and sequentially arranged are assumed to be a sequential pattern. The number of elements contained in the sequential pattern is assumed to be a sequence size of the sequential pattern. The sequential pattern with a sequence size of “i” is called an ith-length sequential pattern. For example, FIG. 14 shows a primary sequential pattern, FIG. 16 shows a secondary sequential pattern, and FIG. 18 shows a tertiary sequential pattern. In FIGS. 16 and 18, “→” indicates the elapse of time. Plural events separated from one another by “→” indicate concurrent events. The support of the sequential pattern defined in Formula (1), described above, is used as a reference value for determining whether or not the pattern is characteristic. The sequential pattern having at least a pre-specified minimum support is considered to be a characteristic sequential pattern. In the present embodiment, the minimum support is specified as “0.5”. This support value is illustrative and is generally derived empirically. The expression “sequential data containing a sequential pattern” in Formula (1) means that all the elements constructing the sequential pattern are contained in elements constructing the sequential data with their sequential order maintained. For example, sequential data on a subject P1 shown in FIG. 7 contains such sequential patterns as “blood pressure=G→blood pressure=R” and “blood pressure=G, exercise=G→blood pressure=R, exercise=R”. However, such sequential patterns as “blood pressure=R<blood pressure=G” and “blood pressure=G, exercise=Y→blood pressure=Y, exercise=R” are not contained in sequential data for the subject P1.

Description will be given of an example of process of a sequential pattern detecting apparatus in accordance with the present embodiment. The sequential data storage unit 1 stores sequential data for subjects P1 to P3 recorded in 2000 to 2002 as shown in FIG. 7. For each sequential data, elements composed of three types of events, that is, blood pressure, exercise, and sugar content, recorded in each year (2000 to 2002) are stored in sequential order. “G”, “Y”, and “R” described for each event indicate indices such as evaluation ranks for the blood pressure, exercise, and sugar content of each of the subjects P1 to P3. The attribute information storage unit 5 stores information on attributes which classifies events into plural groups, as attribute information as shown in FIG. 8.

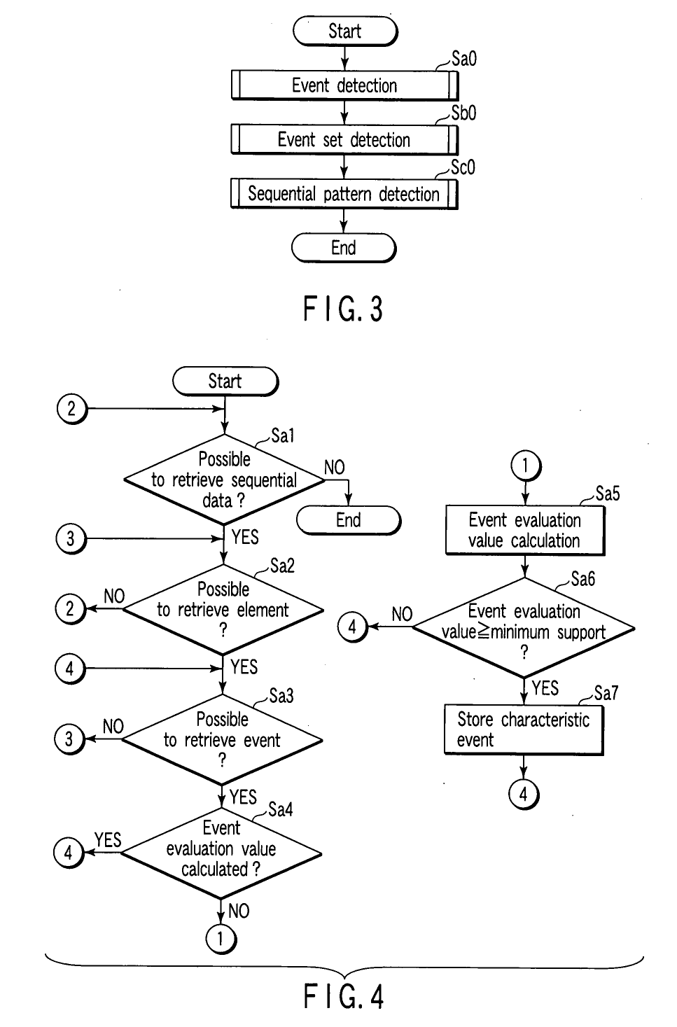

As shown in FIG. 3, the sequential pattern detecting apparatus in accordance with the present embodiment sequentially performs an event detecting process step Sa0 in the event detecting unit 100, an event set detecting process step Sb0 in the event set detecting unit 200, and a sequential pattern detecting process step Sc0 in the sequential pattern detecting unit 300 to detect characteristic sequential patterns. Specifically, in the event detection in step Sa0, event set detection in step Sb0, and sequential pattern detection in step Sc0, the respective processes shown in FIGS. 4, 5, and 6 are performed.

The event detecting process in step Sa0 will be described below in detail with reference to FIG. 4.

First, the event detecting unit 100 refers to the sequential data storage unit 1 to determine whether or not to be able to retrieve sequential data (step Sa1). If the sequential data storage unit 1 stores any unretrieved data (the result of step Sa1 is “YES”), the sequential data decomposing unit 2 retrieves one unretrieved data from the sequential data storage unit 1. The process then proceeds to step Sa2. If all sequential data have been retrieved, the process ends the event detecting process step Sa0 and proceeds to the event set detecting step Sb0. Specifically, to retrieve sequential data for the first time, the sequential data decomposing unit 2 retrieves sequential data for the subject P1 from the sequential data storage unit 1. The process then proceeds to step Sa2. If all the sequential data for the subjects P1 to P3 have already been retrieved, the event detecting process step Sa0 is ended. The process then proceeds to the event set detecting step Sb0.

In step Sa2, the event detecting unit 100 refers to the sequential data retrieved in step Sa1 to determine whether or not to be able to retrieve elements. If the sequential data contains any unretrieved element (the result of step Sa2 is “YES”), the sequential data decomposing unit 2 retrieves an unretrieved one of the elements forming the sequential data retrieved in step Sa1. The process proceeds to step Sa3. Otherwise (the result of step Sa2 is “NO”) the process returns to step Sa1. Specifically, if the elements are extracted, for the first time, from the sequential data for the subject P1 retrieved in step Sa1, the sequential data elements “blood pressure=G, exercise=G, sugar content=G” for the subject P1 recorded in 2000 are retrieved. The process then proceeds to step Sa3. If the sequential data elements for the subject P1 recorded in 2000 to 2002 have already been retrieved, the process then returns to step Sa1.

In step Sa3, the event detecting unit 100 refers to the element retrieved in step Sa2 to determine whether or not to be able to retrieve event. If the element include any unretrieved event (the result of step Sa3 is “YES”), the sequential data decomposing unit 2 retrieves one unretrieved event from the element. The process proceeds to step Sa4. Otherwise (the result of step Sa3 is “NO”) the process returns to step Sa2. Specifically, if an event is extracted, for the first time, from the sequential data elements retrieved in step Sa2, that is, the elements “blood pressure=G, exercise=G, sugar content=G” for the subject P1 recorded in 2000, the event “blood pressure=G” is retrieved. The process then proceeds to step Sa4. If all the events “blood pressure=G”, “exercise=G”, and “sugar content=G”, the sequential data elements for the subject P1 recorded in 2000, have already been retrieved, the process returns to step Sa2.

In step Sa4, the event detecting unit 100 refers to the event retrieved in step Sa3 to determine whether or not an event evaluation value calculation has already been performed. If the event evaluation value calculation, described later, has already performed on the event retrieved in step Sa3 (the result of step Sa4 is “YES”), the process returns to step Sa3. Otherwise (the result of step Sa4 is “NO”) the process proceeds to step Sa5. Specifically, it is assumed that in step Sa3, the event “sugar content=G” is retrieved from the sequential data elements for the subject P1 recorded in 2002. The event detecting unit 100 determines whether or not the event evaluation value calculation has been performed on the event “sugar content=G”. If the event evaluation value calculation has not been performed, the process proceeds to step Sa5. On the other hand, it is assumed that the sequential data elements for the subject P1 recorded in 2000 have already been processed and that the event “sugar content=G” has been retrieved from the sequential data elements for the subject P1 recorded in 2001, which was retrieved in step Sa3. In step Sa4, the event detecting unit 100 determines that the event evaluation value calculation has been performed on the event “sugar=G”. The process returns to step Sa3.

In step Sa5, the event detecting unit 100 calculates event evaluation values. That is, the candidate sequential pattern determining unit 3 calculates the support for each event, that is, an event evaluation value. First, the candidate sequential pattern determining unit 3 refers to sequential data stored in the sequential data storage unit 1 to calculate the number (frequency) of sequential data containing a particular event. Then, the candidate sequential pattern determining unit 3 applies the calculated frequency to Formula (1) to calculate the support for the event. Specifically, if the event detecting unit 100 determines that an event evaluation value has not been calculated for the event “blood pressure=G” in step Sa4, the candidate sequential pattern determining unit 3 calculates its support. As shown in FIG. 7, the event “blood pressure=G” is contained in the sequential data elements for the subject P1 recorded in 2000, the sequential data elements for the subject P2 recorded in 2000, and the sequential data elements for the subject P3 recorded in 2001. Consequently, the event “blood pressure=G” is contained in the sequential data for all the subjects P1 to P3 and thus has an frequency of “3”. Further, the number of sequential data corresponds to the number of the subjects P1 to P3 and is thus “3”. Accordingly, the support of this event is calculated to be “1.0” (=3/3) in accordance with Formula (1). Then, the event detecting unit 100 determines whether or not the event evaluation value is equal to or larger than the minimum support (step Sa6). That is, the candidate sequential pattern determining unit 3 compares the support calculated for the event with the pre-specified minimum support (in the present embodiment, “0.5” as previously described). If the support calculated for the event is not smaller than the minimum support (the result of step Sa6 is “YES”), the candidate sequential pattern determining unit 3 determines the event to be characteristic. The process then proceeds to step Sa7. Otherwise, the process then returns step Sa3. Specifically, for the event “blood pressure=G”, the support is calculated to be “1.0”, which is larger than the minimum support of “0.5”. The process thus proceeds to step Sa7. On the other hand, for example, the event “sugar content=Y” is contained only in the sequential data elements for the subject P2 recorded in 2000 and not in the sequential data for the subjects P1 and P3. Thus, the frequency of this event is “1”. Since the support of this event is calculated to be “0.33” (=1/3) in accordance with Formula (1), which is smaller than the minimum support, the process returns to step Sa3.

In step Sa7, the event detecting unit 100 stores the characteristic event. That is, the characteristic sequential pattern storage unit 4 stores the event determined to be characteristic in step Sa6 as a characteristic event set comprising one event. The process then returns to step Sa4. Specifically, for the event “blood pressure=G”, the characteristic sequential pattern storage unit 4 stores the event as a characteristic event set comprising one event. The process then returns to step Sa4.

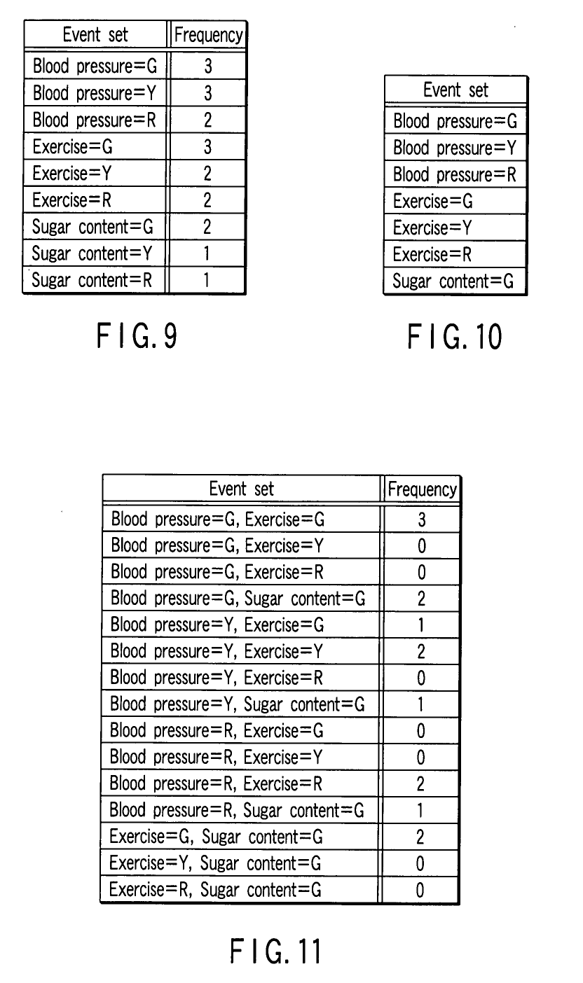

Steps Sa1 to Sa7 allow the detection of all event sets each comprising one event. Specifically, for the sequential data shown in FIG. 7, frequencies are calculated for the other events as in the case of the event “blood pressure=G”, as shown in FIG. 9. The events which have an frequency of at least “2” are calculated to have a support of at least “0.5” on the basis of Formula (1). Accordingly, the events having a support of at least “0.5” are detected as characteristic event sets each comprising one event and the characteristic sequential pattern storage unit 4 stores these characteristic event sets. FIG. 10 shows all the characteristic event sets each comprising one event, detected from the sequential data shown in FIG. 7.

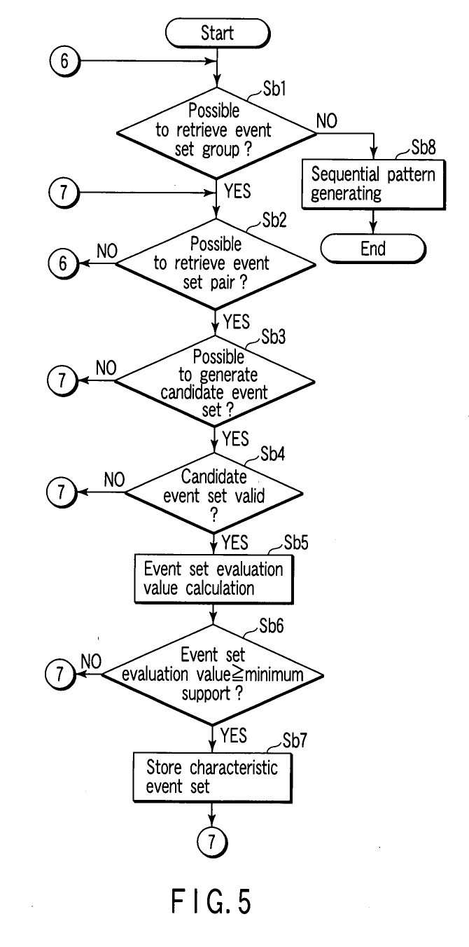

Once the event detecting process in step Sa0, shown in FIG. 3, is thus finished, the process proceeds to step Sb0 to perform the event set detecting process. Now, with reference to FIG. 5, a detailed description will be given of an event set detecting process in step Sb0 shown in FIG. 3.

First, the event set detecting unit 200 determines whether or not to be able to retrieve an event set group (step Sb1). Specifically, if an event set group containing plural event sets corresponding to the current event count can be retrieved from the characteristic sequential pattern storage unit 4 (the result of step Sb1 is “YES”), the candidate sequential pattern generating unit 7 retrieves the event set group corresponding to the current event count from the characteristic sequential pattern storage unit 4. The process proceeds to step Sb2. Otherwise (the result of step Sb1 is “NO”) the process proceeds to step Sb8. If step Sb1 is performed for the first time on, for example, the sequential data shown in FIG. 7, the event count is “1”. Consequently, characteristic event set corresponding to the current event count of “1” is retrieved as shown in FIG. 10. The process then proceeds to step Sb2.

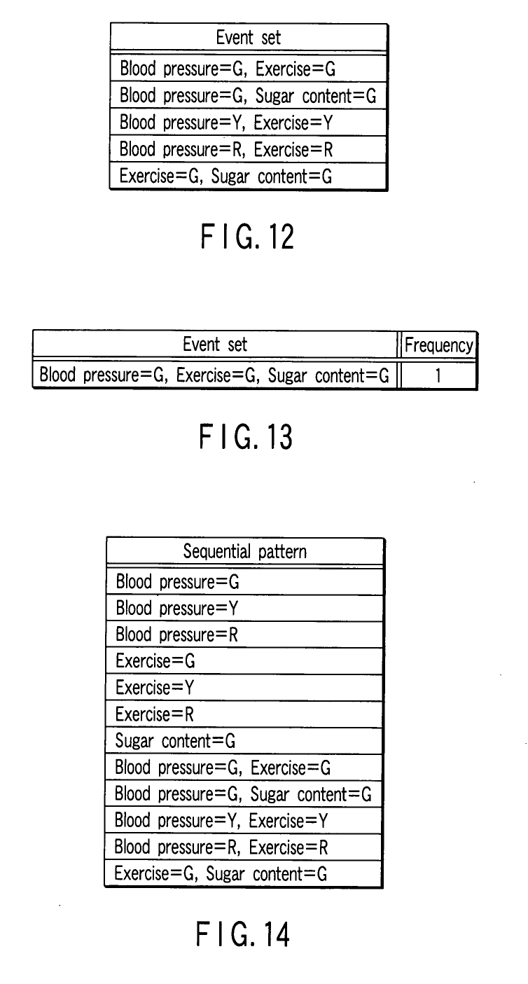

In step Sb2, the event set detecting unit 200 determines whether or not to be able to retrieve an event set pair. Specifically, the candidate sequential pattern generating unit 7 refers to the event set group extracted in step Sb1. If there is any unextracted combination of event sets (the result of step Sb2 is “YES”), the candidate sequential pattern generating unit 7 retrieves one unextracted combination of event sets as one event set pair. The process then proceeds to step Sb3. Otherwise (the result of step Sb2 is “NO”), the candidate sequential pattern generating unit 7 increments the current event count by “1”. The process then returns to step Sb1. For example, it is assumed that step Sb2 is performed for the first time on the sequential data shown in FIG. 7. In this example, since the event count is “1”, the candidate sequential pattern generating unit 7 extracts a combination of any two event sets, for example, “blood pressure=G” and “blood pressure=Y”, from the characteristic event sets shown in FIG. 10, as an event set pair. The process then proceeds to step Sb3. On the other hand, it is assumed that for the sequential data shown in FIG. 7, the event count is “1” and 21 (=₇C₂) event set pairs have been extracted. Then, since all the event set pairs have already been extracted, the candidate sequential pattern generating unit 7 increments the current event count by “1”. The process then returns to step Sb1. When the current event count is “2”, for example, “blood pressure=G, exercise=G” and “blood pressure=G, sugar content=G” are extracted from characteristic event sets shown in FIG. 12 as event set pairs, as described below.

In step Sb3, the event set detecting unit 200 determines whether or not to be able to generate a candidate event set. That is, if the event subsets in each event set pair retrieved in step Sb2 match (the result of step Sb3 is “YES”), the event set detecting unit 200 combines the event set pair together and generates a candidate event set with an event count larger than the current one by “1”. The process then proceeds to step Sb4. Otherwise (the result of step Sb3 is “NO”) the process returns to step Sb2. Here, the event subset is the corresponding event set from which the last event is excluded. For example, the event subset of the “blood pressure=G, exercise=G, sugar content=G” is “blood pressure=G, exercise=G”. For example, it is assumed that in step Sb2, the two event sets “blood pressure=G” and “blood pressure=Y” are retrieved as an event set pair. In this case, the event subsets of the two event sets are both empty and are thus determined to match. The event set detecting unit 200 then generates a candidate event set such as “blood pressure=G, blood pressure=Y” which comprises two events. The process then proceeds to Sb4.

In step Sb4, the event set detecting unit 200 determines whether or not the candidate event set generated in step Sb3 is valid. That is, the attribute information determining unit 6 refers to the attribute information stored in the attribute information storage unit 5 to check the attribute duplication of each of the events constructing the candidate event set. If no duplication is found (the result of step Sb4 is “YES”), the process proceeds to step Sb5. Otherwise (the result of step Sb4 is “NO”), the process returns to step Sb2. Specifically, for a candidate event set such as “blood pressure=G, blood pressure=Y”, these two events belong to the same attribute “blood pressure”. Owing to the presence of the attribute duplication, the process returns to step Sb2. For a candidate event set such as “blood pressure=G, sugar content=G”, these events belong to different attribute. Owing to the lack of an attribute duplication, the process proceeds to step Sb5.

In step Sb5, the event set detecting unit 200 calculates evaluation value for each candidate event set. Specifically, the candidate sequential pattern determining unit 3 refers to the sequential data stored in the sequential data storage unit 1 to calculate the frequency of the sequential data containing the candidate event set. The candidate sequential pattern determining unit 3 further applies Formula (1), described above, to the calculated frequency to calculate a support for the candidate event set. FIG. 11 shows a specific example of valid candidate event sets each comprising two events acquired in step Sb3 and Sb4. The candidate sequential pattern determining unit 3 calculates the frequency of the sequential data for all the candidate event sets. The candidate sequential pattern determining unit 3 further calculates supports. For example, the candidate event set “blood pressure=G, sugar content=G” is contained in the sequential data elements for the subject P1 recorded in 2000 and the sequential data elements for the subject P3 recorded in 2001, as shown in FIG. 7. This candidate event set thus has an frequency of “2”. Further, since the number of sequential data is “3”, the support of this candidate event set is calculated to be “0.67” (=2/3) in accordance with Formula (1). On the other hand, the candidate event set “blood pressure=G, exercise=G” is contained only in the sequential data elements for the subject P3 recorded in 2001, as shown in FIG. 7. This candidate event set thus has an frequency of “1”. Consequently, the support of this candidate event set is calculated to be “0.33” (=1/3) in accordance with Formula (1). Then, the event set detecting unit 200 determines whether or not the event set evaluation value is at least at a minimum support (step Sb6). That is, the candidate sequential pattern determining unit 3 compares the support calculated for the candidate event set with the pre-specified minimum support. If the support calculated for the candidate event set is not smaller than the minimum value (the result of step Sb6 is “YES”), the candidate sequential pattern determining unit 3 determines the candidate event set to be characteristic. The process then proceeds to step Sb7. Otherwise (the result of step Sb6 is “NO”) the process returns to step Sb2. For example, for the above candidate event set “blood pressure=G, sugar content=G”, the support is calculated to be “0.67”. Since the minimum support is specified to be “0.5”, this support is larger than the minimum support and the candidate event set is determined to be characteristic. The process then proceeds to step Sb7. On the other hand, the above candidate event set “blood pressure=Y, exercise=G” has a support of “0.33”, which is smaller than the minimum support. This candidate event set is thus determined not to be characteristic. The process thus returns to step Sb2.

In step Sb7, the event set detecting unit 200 stores the characteristic event set. That is, the characteristic sequential pattern storage unit 4 stores the candidate event set determined to be characteristic in step Sb6. The process then returns to step Sb2. For example, the characteristic sequential pattern storage unit 4 stores the event “blood pressure=G, sugar content=G” as a characteristic event set with an event count of “2”.

The event set detecting process in step Sb0 is thus repeatedly performed on the characteristic event sets with an event count of “1” shown in FIG. 10. This enables the detection of all characteristic event sets with an event count of “2”. That is, steps Sb3 and Sb4 are performed on the other event sets as in the case of the above event set “blood pressure=G, sugar content G”, and their frequencies are calculated in step Sb5. This is shown in FIG. 11. The event sets with an frequency of at least “2” have a support of at least “0.5” in accordance with Formula (1), described above. The event sets with a support of at least “0.5” are detected as characteristic event sets with a sequence size of “1” and an event count of “2” as shown in FIG. 12.

Further, as shown in FIG. 12, the event set detecting process in step Sb0 is repeatedly performed on the characteristic event sets with an event count of “2”. It is assumed that two event sets “blood pressure=G, exercise=G” and “blood pressure=G, sugar content=G” are retrieved as event set pair in step Sb3. In this case, the event subsets of these event sets are both “blood pressure=G” and thus match. Accordingly, a candidate event set with an event count of “3”, “blood pressure=G, exercise=G, and sugar content=G”, is generated. The process then proceeds to step Sb4. On the other hand, it is assumed that two event sets “blood pressure=G, exercise=G” and “exercise=G, sugar content=G” are retrieved as event set pair. In this case, the event subsets of these event sets are “blood pressure=G” and “exercise=G”, which do not match. The process then returns to step Sb2.

Further, it is assumed that a candidate event set “blood pressure=G, exercise=G, sugar content=G” is generated in step Sb3. Then, since these three events belong to the different attributes and have no attribute duplication, the process proceeds to step Sb5. On the other hand, it is assumed that a candidate event set such as “blood pressure=G, exercise=G, exercise=Y” is generated in step Sb3. Then, since the events “exercise=G” and “exercise=Y” belong to the same attribute “exercise” and have an attribute duplication, the process returns to step Sb2.

The event set detecting process in step Sb0 is thus repeatedly performed on the characteristic event sets with an event count of “2” shown in FIG. 12. This enables the detection of a candidate event set with an event count of “3” and calculation of its frequency shown in FIG. 13. The events with an frequency of at least “2” have a support of at least “0.5” in accordance with Formula (1). However, no appropriate candidate is found in the candidate event set with an event count of “3” shown in FIG. 13. Consequently, no characteristic event set with an event count of “3” is detected. The process is thus returns to step Sb2. In step Sb2, no combination of characteristic event sets to be retrieved is found. The process thus returns to step Sb1. In step Sb1, no characteristic event set with an event count of “3” is found. The process thus determines that no event set corresponding to a new event count of “3” can be retrieved and proceeds to step Sb8.

In step Sb8, the event set detecting unit 200 generates primary sequential patterns. Specifically, the candidate sequential pattern generating unit 7 regards characteristic event sets with a sequence size of “1” stored in the characteristic sequential pattern storage unit 4 as the primary sequential patterns. The characteristic sequential pattern storage unit 4 then stores the primary sequential pattern to finish the event set detecting step Sb0. Specifically, for the sequential data in FIG. 7, characteristic event sets with a sequence size of “1” shown in FIG. 14 are regarded as primary sequential patterns, which are then stored in the characteristic sequential pattern storage unit 4.

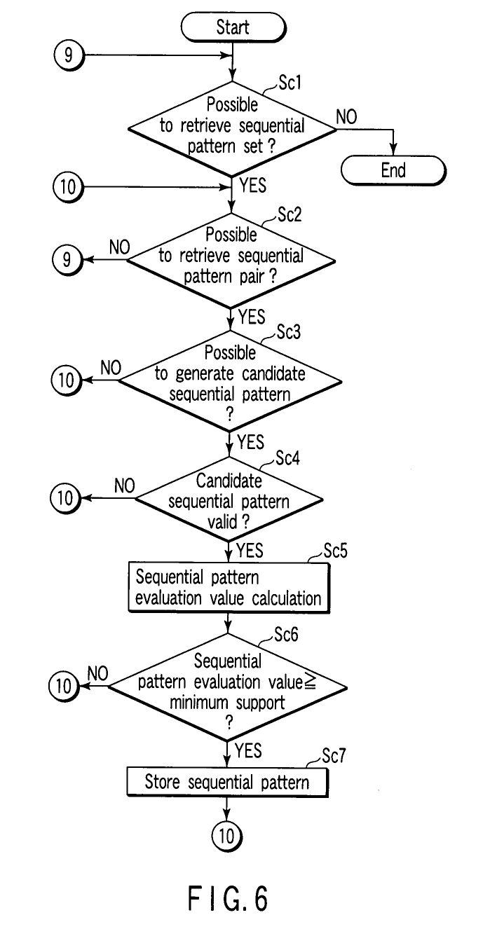

Once the event set detecting process in step Sb0, shown in FIG. 3, is thus finished, the process proceeds to step Sc0 to perform a sequential pattern detecting process. Now, the sequential pattern detecting process in step Sc0 shown in FIG. 3 will be described below in detail with reference to FIG. 6.

In step Sc1, the sequential pattern detecting unit 300 determines whether or not to be able to retrieve sequential pattern sets. Specifically, if sequential pattern sets corresponding to the current sequence size can be retrieved from the characteristic sequential pattern storage unit 4 (the result of step Sc1 is “YES”), the candidate sequential pattern generating unit 7 retrieves sequential pattern sets corresponding to the current sequence size from the characteristic sequential pattern storage unit 4. The process then proceeds to step Sc2. Otherwise (the result of step Sc1 is “NO”) the sequential pattern detecting unit 300 ends the sequential pattern detecting process step Sc0. If step Sc1 is performed for the first time, the sequence size is “1”. Accordingly, to perform step Sc1 for the first time on the sequential data in FIG. 7, the sequential pattern detecting process unit 300 retrieves the primary sequential patterns shown in FIG. 14. The process then proceeds to step Sc2.

In step Sc2, the sequential pattern detecting unit 300 determines whether or not to be able to retrieve sequential pattern pair. Specifically, the candidate sequential pattern generating unit 7 refers to the sequential pattern sets extracted in step Sc1, and if any combination of two sequential patterns has not been extracted yet (the result of step Sc2 is “YES”), the candidate sequential pattern generating unit 7 retrieves one unextracted combination of two sequential patterns as a sequential pattern pair. The process then proceeds to step Sc3. Otherwise (the result of step Sc2 is “NO”) the candidate sequential pattern generating unit 7 increments the current sequence size by “1”. The process then returns to step Sc1. In step Sc2, a combination of two identical sequential patterns can also be retrieved. Further, a combination of two sequential patterns is considered to be different from another combination of the same two sequential patterns if the arrangement order of these sequential patterns is different between the two combinations. Specifically, to perform step Sc2 for the first time on the sequential data shown in FIG. 7, the candidate sequential pattern generating unit 7 retrieves combinations each of any two sequential patterns from the sequential patterns shown in FIG. 14, for example, “blood pressure=G” and “blood pressure=G”, as a sequential pattern pair. Subsequently, combinations each of two sequential patterns such as “blood pressure=G” and “blood pressure=Y” as well as “blood pressure=G” and “blood pressure=R” are retrieved one after another as sequential pattern pairs. If 144 (=12²) combinations have been extracted from the sequential patterns shown in FIG. 14, then the candidate sequential pattern generating unit 7 increments the current sequence size by “1” because all the combinations each of two sequential patterns have been extracted. The sequence size is incremented by “1”, and the process then returns to step Sc1. For a sequence size of “2”, to which the current sequence size is incremented by “1”, an attempt is made to extract combinations of any two sequential patterns from the sequential patterns shown in FIG. 16.

In step Sc3, the sequential pattern detecting unit 300 determines whether or not to be able to generate a candidate sequential pattern. Specifically, for the sequential pattern pair retrieved in step Sc2, when partial sequential patterns of the two sequential patterns match (the result of step Sc3 is “YES”), the candidate sequential pattern generating unit 7 combines the paired sequential patterns into a candidate sequential pattern with a sequence size larger than the current one by “1”. The process then proceeds to step Sc4. Otherwise (the result of step Sc3 is “NO”) the process returns to step Sc2. Here, the partial sequential pattern is the corresponding sequential pattern from which the last element is excluded. For example, the partial sequential pattern of “blood pressure=G→blood pressure=Y→blood pressure→R” is “blood pressure=G→blood pressure=Y”. For example, it is assumed that a sequential pattern of “blood pressure=G” and “blood pressure=Y” with a sequence size of “1” is retrieved in step Sc2 as a sequential pattern pair. In this example, the partial sequential patterns of these sequential patterns are both empty and thus match. The candidate sequential pattern generating unit 7 thus generates a candidate secondary sequential pattern “blood pressure=G→blood pressure=Y”. The process then proceeds to step Sc4.

In step Sc4, the sequential pattern detecting unit 300 determines whether or not the candidate sequential pattern generated in step Sc3 is valid. First, the attribute information determining unit 6 checks the candidate sequential pattern for its sequence size. If the sequence size is at least “3”, the process unconditionally proceeds to step Sc5. If the sequence size is “2”, the attribute information determining unit 6 refers to the attribute information stored in the attribute information storage unit 5 to compare the attributes of the events of the elements constructing the candidate secondary sequential pattern. If the attributes match (the result of step Sc4 is “YES”), the process proceeds to step Sc5. Otherwise (the result of step Sc4 is “NO”) the process returns to step Sc2. Specifically, if the candidate secondary sequential pattern is “blood pressure=G→blood pressure=Y”, the process proceeds to step Sc5 because the attributes of the events of the elements constructing the candidate secondary sequential pattern are both “blood pressure” and thus match. If the candidate secondary sequential pattern is “blood pressure=G→exercise=G”, the process returns to step Sc2 because the attributes of the events of the elements constructing the candidate secondary sequential pattern are “blood pressure” and “exercise” and do not match. If the candidate secondary sequential pattern is “blood pressure=G, exercise=G→blood pressure=Y, exercise=Y”, the process proceeds to step Sc5 because, for the elements “blood pressure=G, exercise=G” and “blood pressure=Y, exercise=Y”, the attributes of the events are both “blood pressure” and “exercise” and thus match. If the candidate secondary sequential pattern is “blood pressure=G, exercise=G→blood pressure=G, sugar content=G”, the process returns to step Sc2 because, in spite of the matching attribute “blood pressure”, the elements “blood pressure=G, exercise=G” and “blood pressure=G, sugar content=G” have different attributes, that is, “exercise” and “sugar content”.

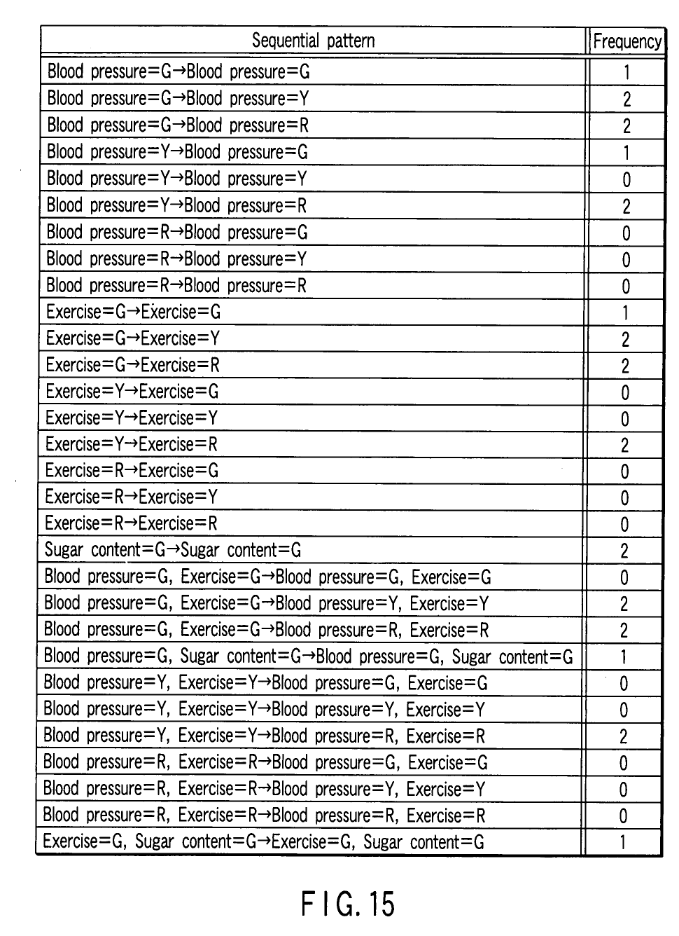

In step Sc5, the sequential pattern detecting unit 300 calculates sequential pattern evaluation value. Specifically, the candidate sequential pattern determining unit 3 refers to the sequential data stored in the sequential data storage unit 1 to calculate the frequency of the candidate sequential pattern. The candidate sequential pattern determining unit 3 further applies Formula (1), described above, on the basis of the frequency to calculate the support for the candidate sequential pattern. FIG. 15 shows a specific example of valid candidate secondary sequential patterns acquired in steps Sc3 and Sc4. For all the valid candidate secondary sequential patterns, the frequency is calculated to acquire the support. For example, the candidate sequential pattern “blood pressure=G→blood pressure=Y” is contained in the sequential data elements for both the subjects P1 and P2 as sown in FIG. 7, and thus has an frequency of “2”. The support of this candidate sequential pattern is calculated to be “0.67” (=2/3) in accordance with Formula (1). On the other hand, the candidate sequential pattern “blood pressure=Y→blood pressure=G” is contained only in the sequential data elements for the subject P3 as sown in FIG. 7, and thus has an frequency of “1”. The support of this candidate sequential pattern is calculated to be “0.33” (=1/3) in accordance with Formula (1). Then, the sequential pattern detecting unit 300 determines whether or not the sequential pattern evaluation value is at least at the minimum support (step Sc6). That is, the candidate sequential pattern determining unit 3 compares the support calculated for the candidate sequential pattern with the pre-specified minimum support. If the support calculated for the candidate event set is the minimum support (the result of step Sc6 is “YES”), the candidate sequential pattern determining unit 3 determines the candidate sequential pattern to be characteristic. The process then proceeds to step Sc7. Otherwise (the result of step Sc6 is “NO”) the process returns to step Sc2. For example, for the candidate sequential pattern “blood pressure=G→blood pressure Y”, the support is calculated to be “0.67”, which is larger than the minimum support of “0.5”. The candidate sequential pattern determining unit 3 determines the candidate sequential pattern to be characteristic, and the process proceeds to step Sc7. On the other hand, the candidate sequential pattern “blood pressure=Y→blood pressure=G” has a support of “0.33”, which is smaller than the minimum support of “0.5”. This candidate sequential pattern is thus determined not to be characteristic. The process thus returns to step Sc2.

In step Sc7, the sequential pattern detecting unit 300 stores the characteristic sequential pattern. That is, the characteristic sequential pattern storage unit 4 stores the sequential pattern determined to be characteristic in step Sc6. The process then returns to step Sc2. For example, the secondary sequential pattern “blood pressure=G→blood pressure=Y” is stored in the characteristic sequential pattern storage unit 4 as a characteristic secondary sequential pattern.

The sequential pattern detecting process in step Sc0 is thus repeatedly performed on the primary sequential patterns shown in FIG. 14. This enables the detection of characteristic secondary sequential patterns such as those shown in FIG. 16.

Then, with the sequence size set to “2”, the sequential pattern detecting process in step Sc0 is thus repeatedly performed on characteristic secondary sequential patterns such as those shown in FIG. 16.

In step Sc3, for example, the two sequential patterns “blood pressure=G→blood pressure=Y” and “blood pressure=G→blood pressure=R” have the same partial sequential pattern “blood pressure=G”. Accordingly, a candidate tertiary sequential pattern “blood pressure=G→blood pressure=Y→blood pressure=R” is generated, and the process proceeds to step Sc4. On the other hand, for example, the two sequential patterns “blood pressure=G→blood pressure=Y” and “exercise=G→exercise=Y” have the different sequential patterns “blood pressure=G” and “exercise=G”. The process thus returns to step Sc2.

In step Sc4, for example, for a candidate tertiary sequential pattern such as “blood pressure=G→blood pressure=Y→blood pressure=R”, the process immediately proceeds to step Sc5 because the sequential pattern has a sequence size of “3”.

A similar process is then performed to enable candidate tertiary sequential patterns shown in FIG. 17 to be extracted from the secondary sequential patterns shown in FIG. 16. Then, as shown in FIG. 17, for all the candidate tertiary sequential patterns, the frequency of the sequential data is calculated and the support is acquired. This enables the detection of characteristic tertiary sequential patterns such as those shown in FIG. 18. The characteristic sequential patterns storage unit 4 stores the characteristic tertiary sequential patterns.

Then, with the sequence size set to “3”, the sequential pattern detecting process in step Sc0 is thus repeatedly performed on the characteristic tertiary sequential patterns shown in FIG. 18.

In step Sc3, for example, the two sequential patterns “blood pressure=G→blood pressure=Y→blood pressure=R” and “blood pressure=G→blood pressure=Y→blood pressure=R” have the same partial sequential pattern “blood pressure=G→blood pressure=Y”. Accordingly, a quartic sequential pattern “blood pressure=G→blood pressure=Y→blood pressure=R→blood pressure=R” is generated, and the process proceeds to step Sc4. On the other hand, for example, the two sequential patterns “blood pressure=G→blood pressure=Y→blood pressure=R” and “exercise=G→exercise=Y→exercise=R” have the different partial sequential patterns “blood pressure=G→blood pressure=Y” and “exercise=G→exercise=Y”. The process thus returns to step Sc2.

In step Sc4, for example, for a candidate quartic sequential pattern such as “blood pressure=G→blood pressure=Y→blood pressure=R→blood pressure=R”, the process immediately proceeds to step Sc5 because the sequential pattern has a sequence size of “4”.

A similar process is then performed to enable the acquisition of candidate quartic sequential patterns shown in FIG. 19 from the tertiary sequential patterns shown in FIG. 18. Then, for all the candidate quartic sequential patterns, the frequency of the sequential data is calculated. However, the sequential data shown in FIG. 7 corresponds to up to the tertiary sequential patterns. Consequently, the frequencies of the candidate quartic sequential patterns are all “0” as shown in FIG. 19, with no characteristic quartic sequential pattern detected.

For the sequential data shown in FIG. 7, no characteristic quartic sequential pattern has a sequence size of “4” as shown in FIG. 19. The sequential pattern detecting process step Sc0 is thus ended.

As described above, the present embodiment detects a characteristic sequential patterns with a sequence size “2” from combination of two characteristic sequential patterns with a sequence size of “1”, and sequentially increments the sequence size by “1”, while generating an (i+1)th-length characteristic sequential pattern with a sequence size of (i+1) from combination of two characteristic sequential patterns with a sequence size of “i”. Once all the characteristic sequential patterns are detected, the sequential pattern detecting process in step Sc0 is finished to complete all of the process performed by the sequential pattern detecting apparatus in accordance with the embodiment. That is, for the sequential data shown in FIG. 7, the sequential pattern detecting unit in accordance with the embodiment detects the characteristic primary to tertiary sequential patterns shown in FIGS. 14, 16, and 18 and completes all of the process.

The present embodiment can also check the invalidity of a candidate event set containing a combination of events belonging to the same attribute and having no possibility of coincidental occurrence, to exclude the candidate event set from the determination as to whether or not the candidate event set is characteristic. This enables a sharp reduction in the number of candidate event sets for which it is necessary to determine whether or not they are characteristic. For example, for the sequential data in FIG. 7, it is unnecessary to determine whether or not the candidate event sets “blood pressure=G, blood pressure=Y” and “blood pressure=G, exercise=G, exercise=Y” are characteristic.

The present embodiment can also determine that sequential patterns in which the events contained in the elements belong to different attributes are invalid, to exclude these sequential patterns from the determination as to whether or not the sequential patterns are characteristic. This enables a sharp reduction in the number of candidate sequential patterns for which it is necessary to determine whether or not they are characteristic. For example, for the sequential data in FIG. 7, it is unnecessary to determine whether or not the candidate sequential patterns “blood pressure=G→exercise=G” and “blood pressure=G, exercise=G→blood pressure=G, sugar content=G” are characteristic.

The sequential patterns shown in FIG. 7 are composed of the three sequential data for simplicity. However, this is only illustrative, several thousand or ten thousand data are actually used, requiring much calculation time for determining whether or not they are characteristic. Accordingly, characteristic sequential patterns can be accurately and quickly detected by minimizing the number of candidate sequential patterns for which it is necessary to determine whether or not they are characteristic. On the other hand, only the sequential pattern following a variation in the event belonging to the same attribute is extracted, allowing analyzers to easily extract truly characteristic sequential patterns. Specifically, for the sequential data, the present embodiment avoids extracting sequential patterns such as “blood pressure=G→exercise=Y” and “blood pressure=G→exercise=Y→blood pressure=R” in which the events contained in the elements belong to different attributes and which are extracted in accordance with the conventional methods. This allows sequential patterns that are truly characteristic for the analyzer to be easily detected in detected characteristic sequential patters.

### (Modification)

In the above embodiment, the attributes stored in the attribute information storage unit 5 are configured without specifying a hierarchical structure for events belonging to the same attribute column. However, the attributes may be configured with a hierarchical structure specified. For example, it is assumed that such events as those shown in FIG. 20 belong to the attribute “alcohol consumption”. If the events “alcohol consumption=drinks: beer”, “alcohol consumption=drinks: wine”, “alcohol consumption=drinks: sake”, and “alcohol consumption=drinks: shochu” have a possibility of coincidental occurrence, the attributes can be configured as shown in FIG. 21.

The attributes configured as shown in FIG. 21 allows the attribute information determining unit 6 to prevent the coincidental occurrence of higher classification criteria “alcohol consumption=drinks” and “alcohol consumption=doesn't drink” in step Sb4 as described above. However, the attribute information determining unit 6 allows the coincidental occurrence of lower classification criteria “alcohol consumption=drinks: wine”, “alcohol consumption=drinks: sake”, and “alcohol consumption: drinks: shochu”.

Further, in step Sc4, regardless of the number of events contained in the attribute “alcohol consumption”, the attribute information determining unit 6 can determine whether or not to proceed to step Sc5 on the basis of the presence or absence of an event belonging to this attribute. This determination prevents a sequential pattern such as “alcohol consumption=doesn't drink→blood pressure=G” from proceeding to step Sc5, while allowing a sequential pattern such as “alcohol consumption=doesn't drink→alcohol consumption=drinks: wine→alcohol consumption=drinks: beer, alcohol consumption=drinks: wine” to proceed to step Sc5.

Further, for example, in step Sc4, the determination can be made with restrictions on a variation in event. Specifically, the process may proceed to step Sc5 if the event belonging to the attribute “blood pressure” changes like “blood pressure=G→blood pressure=Y” but not if the event belonging to the attribute “blood pressure” does not change like “blood pressure G→blood pressure=G”.

The above embodiment provides the event detecting unit 100, shown in FIG. 1. However, for example, pre-acquired data on characteristic event sets can be utilized to implement the sequential pattern detecting apparatus in accordance with the embodiment of the present invention even with the event detecting unit 100 omitted.

The above embodiment utilizes the support of each sequential pattern as a reference value for determining whether or not the sequential pattern is characteristic. However, a sequence interest level may be utilized in place of the support. The sequence interest level is described in Shigeaki Sakurai, Youichi Kitahara, and Ryohei Orihara: “Sequential Mining Method based on a New Criterion”, Proceedings the 10th IASTED International Conference on Artificial Intelligence and Soft Computing, 544-045(2006). For example, if a particular sequential pattern includes a partial sequential pattern with not a very high relative frequency, it can accurately predict the remaining events contained in itself when the partial sequential pattern with not a very high relative frequency is provided. Accordingly, this sequential pattern can be considered to be a kind of characteristic sequential pattern. Thus, not a very high relative frequency is evaluated using the minimum value of reciprocal of the frequency of the partial sequential pattern included in the sequential pattern. This is defined as an index for detection of such a sequential pattern.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sequential pattern detecting apparatus comprising:
a first combining unit configured to combine a plurality of characteristic event sets comprised in sequential data containing elements which comprise a plurality of events with attributes and which are arranged in sequential order, to generate a candidate event set;
a first checking unit configured to check validity of the candidate event set on the basis of the attributes of the events comprised in the candidate event set to detect a valid event set;
a first detecting unit configured to detect a characteristic primary sequential pattern with a sequence size of “1” from the valid event set with reference to the sequential data;
a second combining unit configured to combine a plurality of characteristic ith-length (i=1, 2, . . . ) sequential patterns with a sequence size of “i” to generate a candidate (i+1)th-length sequential pattern;
a second checking unit configured to check validity of the candidate (i+1)th-length sequential pattern on the basis of the attributes to detect valid (i+1)th-length sequential patterns; and
a second detecting unit configured to detect a characteristic (i+1)th-length sequential pattern from the valid (i+1)th-length sequential patterns with reference to the sequential data.

2. The apparatus according to claim 1, wherein the first combining unit is configured to, if subsets of any two of the characteristic event sets match, combine the two characteristic event sets to generate the candidate event set, the subset corresponding to the event set from which the last event is excluded.

3. The apparatus according to claim 1, wherein the first checking unit is configured to, if the attributes of a plurality of events included in the candidate event set do not duplicate, determine the candidate event set to be the valid event set.

4. The apparatus according to claim 1, wherein the first detecting unit is configured to detect the characteristic primary sequential pattern on the basis of frequency of the valid event set.

5. The apparatus according to claim 1, wherein the second combining unit is configured to, if (i−1)th-length sequential patterns obtained by excluding a last element from each of any two of the characteristic ith-length sequential patterns match, combine the two characteristic ith-length sequential patterns to generate the candidate (i+1)th-length sequential pattern.

6. The apparatus according to claim 1, wherein the second checking unit is configured to, if the attributes of the events contained in the plurality of elements constructing the candidate (i+1)th-length sequential pattern match, determine the candidate (i+1)th-length sequential pattern to be the valid (i+1)th-length sequential pattern.

7. The apparatus according to claim 1, wherein the second detecting unit is configured to detect the characteristic (i+1)th-length sequential pattern on the basis of frequency of the valid (i+1)th-length sequential pattern.

8. The apparatus according to claim 1, further comprising:
a generating unit configured to generate a candidate event from the sequential data; and
a third detecting unit configured to detect the characteristic event from the candidate events.

9. The apparatus according to claim 8, wherein the third detecting unit is configured to detect the characteristic event set on the basis of frequency of the candidate event.

10. The apparatus according to claim 9, wherein the third detecting unit is configured to detect the characteristic event set on the basis of comparison between a support calculated on the basis of the frequency and a pre-specified minimum support.

11. The apparatus according to claim 8, wherein the first combining unit is configured to, if subsets of any two of the characteristic event sets match, combine the two characteristic event sets to produce the candidate event set, the subset corresponding to the event set from which the last event is excluded.

12. The apparatus according to claim 8, wherein the first checking unit is configured to, if the attributes of a plurality of events included in the candidate event set fails to duplicate, determine the candidate event set to be the valid event set.

13. The apparatus according to claim 8, wherein the first detecting unit is configured to detect the characteristic primary sequential pattern on the basis of frequency of the valid event set.

14. The sequential pattern detecting apparatus according to claim 13, wherein the first detecting unit is configured to detect the characteristic primary sequential pattern on the basis of comparison between a support calculated on the basis of the frequency and a pre-specified minimum support.

15. The apparatus according to claim 8, wherein the second combining unit is configured to, if (i−1)th-length sequential patterns obtained by excluding the last element from each of any two of the characteristic ith-length sequential patterns match, combine the two characteristic ith-length sequential patterns to produce the candidate (i+1)th-length sequential pattern.

16. The apparatus according to claim 8, wherein the second checking unit is configured to, if the attributes of the events contained in the plurality of elements constructing the candidate (i+1)th-length sequential pattern, determine the candidate (i+1)th-length sequential pattern to be the valid (i+1)th sequential pattern.

17. The apparatus according to claim 8, wherein the second detecting unit is configured to detect the characteristic (i+1)th-length sequential pattern on the basis of frequency of the valid (i+1)th-length sequential pattern.

18. The apparatus according to claim 17, wherein the second detecting unit is configured to detect the characteristic (i+1)th-length sequential pattern on the basis of comparison between a support calculated on the basis of the frequency and a pre-specified minimum support.

19. A method for detecting a sequential pattern, the method comprising:
combining a plurality of characteristic event sets comprised in sequential data containing elements which comprise a plurality of events with attributes and which are arranged in sequential order, to generate a candidate event set;
checking validity of the candidate event set on the basis of the attributes of the events comprised in the candidate event set to detect a valid event set;
detecting a characteristic primary sequential pattern with a sequence size of “1” in the valid event sets with reference to the sequential data;
combining a plurality of characteristic ith-length (i=1, 2, . . . ) sequential patterns with a sequence size of “i” to generate a candidate (i+1)th-length sequential pattern;
checking validity of the candidate (i+1)th-length sequential pattern on the basis of the attributes to detect valid (i+1)th-length sequential patterns; and
detecting a characteristic (i+1)th-length sequential pattern from the valid (i+1)th-length sequential patterns with reference to the sequential data.

20. A computer readable storage medium storing instructions of a computer program which when executed by a computer results in performance of steps comprising:
combining a plurality of characteristic event sets comprised in sequential data containing elements which comprise a plurality of events with attributes and which are arranged in sequential order, to generate a candidate event set;
checking validity of the candidate event set on the basis of the attributes of the events comprised in the candidate event set to detect a valid event set;
detecting a characteristic primary sequential pattern with a sequence size of “1” from the valid event sets with reference to the sequential data;
combining a plurality of characteristic ith-length (i=1, 2, . . . . ) sequential patterns with a sequence size of “i” to generate a candidate (i+1)th-length sequential pattern;
checking validity of the candidate (i+1)th-length sequential pattern on the basis of the attributes to detect valid (i+1)th-length sequential patterns; and
detecting a characteristic (i+1)th-length sequential pattern from the valid (i+1)th-length sequential patterns with reference to the sequential data.
